(19) United States
(12) Patent Application Publication
(10) Pub. No.: US 2024/0236689 A1
(43) Pub. Date: Jul. 11, 2024

(54) MOBILE ELECTRONIC DEVICE, SYSTEM FOR USING MOBILE ELECTRONIC DEVICE AND METHOD THEREOF

(71) Applicant: Wistron NeWeb Corporation, Hsinchu (TW)

(72) Inventors: Chi-Hsuan HUANG, Hsinchu (TW); Wen-Jin LEE, Hsinchu (TW); Cheng Jung WEN, Hsinchu (TW)

(21) Appl. No.: 18/403,833

(22) Filed: Jan. 4, 2024

(30) Foreign Application Priority Data
Jan. 5, 2023 (TW) 112100338

(51) Int. Cl. H04W 12/60; H04W 64/00

(52) U.S. Cl. CPC H04W 12/66; H04W 64/00

(57) ABSTRACT

A system for using the mobile electronic device includes an external device, a communication device, and the mobile electronic device. The mobile electronic device includes a positioning module, a wireless communication module, and a processor. The positioning module is configured to generate a positioning signal. The wireless communication module detects the communication device and obtains a wireless network name to be confirmed. The processor confirms whether the positioning signal is located within a positioning coordinate range to generate a position confirmation result, and confirms whether the wireless network name to be confirmed is a trusted SSID to generate a network confirmation result. When the position confirmation result is yes and the network confirmation result is yes, a stored data of the mobile electronic device is sent to the external device through the communication device.

### RELATED APPLICATIONS

This application claims priority to Taiwan Application Serial Number No. 112100338, filed Jan. 5, 2023, which is herein incorporated by reference.

### BACKGROUND

### Technical Field

The present disclosure relates to a communication technology field, and more particularly, to a system and method for enabling a mobile electronic device to have cloud services through a fixed network connection point.

### Description of Related Art

Currently, dashboard camera products must include Long Term Evolution (LTE) technology or connect to wireless networks in order to have access to the cloud system. However, these products are priced high and require additional telecommunications costs, and there may be no network service in areas with poor reception. In addition, continuously uploading data during driving will occupy system resources and cause the device to heat up, reducing the device's lifespan. Moreover, there is also a risk of data leakage by connecting to random or unknown wireless network for data uploading.

In view of this, a mobile electronic device, a system, and a method that can save telecommunication expenses, reduce system load, and ensure the security of network data transmission while allowing mobile electronic devices to have cloud services are indeed highly anticipated by the public and become the goal and the direction of relevant industry efforts.

### SUMMARY

According to one aspect of the present disclosure, a mobile electronic device includes a positioning module, a wireless communication module and a processor. The positioning module is for generating a positioning signal. The wireless communication module is for detecting a communication device and obtaining a wireless network name to be confirmed. The processor is signally connected to the positioning module and the wireless communication module. The processor generates a position confirmation result by confirming whether the positioning signal is within a position coordinate range, and generates a network confirmation result by confirming whether the wireless network name to be confirmed is a trusted Service Set Identifier (SSID). When the position confirmation result is yes and the network confirmation result is yes, the processor sends a stored data through the wireless communication module and the communication device to an external device signally connected to the communication device.

According to another aspect of the present disclosure, a system for using a mobile electronic device includes an external device, a communication device, and a mobile electronic device. The communication device is signally connected to the external device. The mobile electronic device is signally connected to the communication device. The mobile electronic device includes a positioning module, a wireless communication module and a processor. The positioning module is for generating a positioning signal. The wireless communication module is for detecting the communication device to obtain a wireless network name to be confirmed. The processor is signally connected to the positioning module and the wireless communication module. The processor generates a position confirmation result by confirming whether the positioning signal is within a position coordinate range, and generates a network confirmation result by confirming whether the wireless network name to be confirmed is a trusted SSID. When the position confirmation result is yes and the network confirmation result is yes, the processor sends a stored data through the wireless communication module and the communication device to the external device.

According to another aspect of the present disclosure, a method for using a mobile electronic device includes: driving a positioning module of the mobile electronic device to generate a positioning signal; driving a processor of the mobile electronic device to confirm whether the positioning signal is within a position coordinate range and generate a position confirmation result; driving a wireless communication module of the mobile electronic device to detect a communication device and obtain a wireless network name to be confirmed; and driving the processor of the mobile electronic device to confirm whether the wireless network name to be confirmed is a trusted SSID and generate a network confirmation result. When the position confirmation result is yes and the network confirmation result is yes, the processor sends a stored data through the wireless communication module and the communication device to an external device.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a mobile electronic device according to a first embodiment of the present disclosure.

FIG. 2 is a block diagram of a system for using a mobile electronic device according to a second embodiment of the present disclosure.

FIG. 3 is a flow chart of a method for using a mobile electronic device according to a third embodiment of the present disclosure.

FIG. 4 is a schematic view illustrating a scenario of the system for using a mobile electronic device of FIG. 2.

FIG. 5 is a flow chart of a method for using a mobile electronic device according to a fourth embodiment of the present disclosure.

FIG. 6 is a flow chart of a method for using a mobile electronic device according to a fifth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

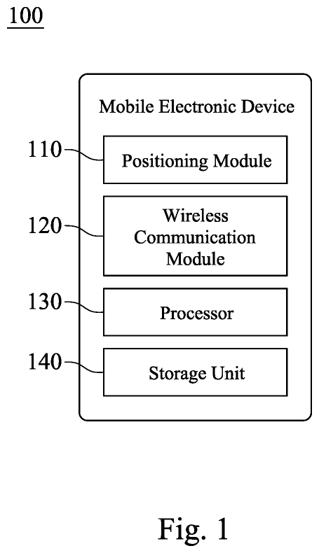

Referring to FIG. 1. FIG. 1 is a block diagram of a mobile electronic device 100 according to a first embodiment of the present disclosure. The mobile electronic device 100 is signally connected to an external device through a communication device at a fixed location, and so is able to gain access to the cloud service. The mobile electronic device 100 includes a positioning module 110, a wireless communication module 120, a processor 130, and a storage unit 140.

The positioning module 110 is configured to generate a positioning signal. In this embodiment, the positioning module 110 is a global positioning system (GPS), but the present disclosure is not limited thereto. The wireless communication module 120 is configured to detect a communication device so as to obtain a wireless network name to be confirmed. The processor 130 is signally connected to the positioning module 110, the wireless communication module 120, and the storage unit 140. The processor 130 is configured to confirm whether the positioning signal of the positioning module 110 is within a position coordinate range so as to generate a position confirmation result, and to confirm whether the wireless network name to be confirmed that is obtained by the wireless communication module 120 is a trusted SSID so as to generate a network confirmation result. When the position confirmation result and the network confirmation result are both yes (affirmative), the processor 130 sends a stored data to the external device through the wireless communication module 120 and the communication device. The position coordinate range, the trusted SSID, and the stored data are stored in the storage unit 140.

In one embodiment, the position coordinate range is a range with a radius of 10 meters from the GPS coordinates of the communication device, the trusted SSID is the domain name of a communication device authenticated by the processor 130, and the stored data includes video recordings, GPS coordinates, and G-sensor data recorded by the mobile electronic device 100 while the vehicle is traveling. In addition, the processor 130 can be a digital signal processor (DSP), a micro processing unit (MPU), a central processing unit (CPU), or other electronic processors. Furthermore, the storage unit 140 can be any data storage element, such as a subscriber identity module (SIM), a read-only memory (ROM), or a random-access memory (RAM), CD-ROMs, magnetic tapes, floppy disks, or optical data storage devices, but the present disclosure is not limited thereto.

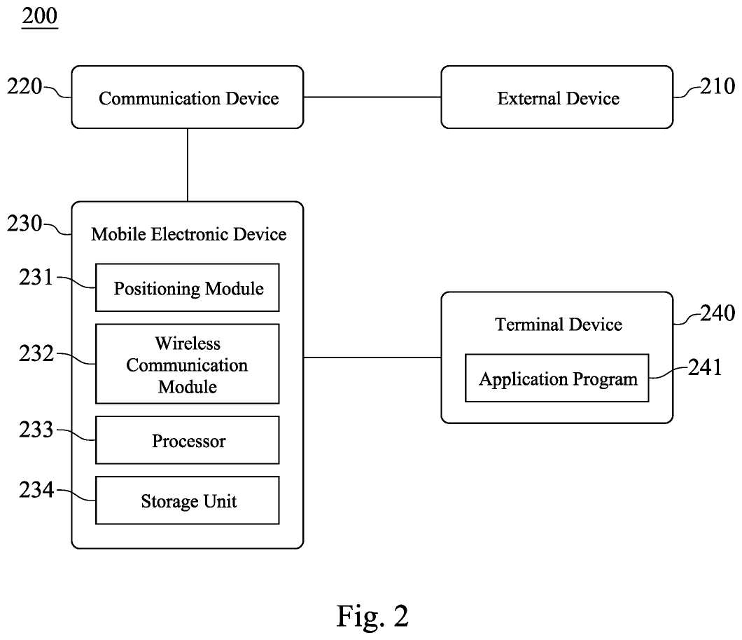

Referring to FIG. 1 and FIG. 2. FIG. 2 is a block diagram of a system 200 for using a mobile electronic device according to a second embodiment of the present disclosure. The system 200 for using a mobile electronic device allows the mobile electronic device 230 to access cloud services and includes an external device 210, a communication device 220, a mobile electronic device 230, and a terminal device 240. The communication device 220 is disposed at the fixed location and the mobile electronic device 230 is disposed on a vehicle. The communication device 220 is signally connected to the external device 210 and the mobile electronic device 230, and the terminal device 240 is signally connected to the mobile electronic device 230.

In this embodiment, the external device 210 can be a cloud server or a cloud host; the communication device 220 can be a data communication equipment (DCE) such as a customer-premises equipment (CPE), a modem, a gateway, a router, a bridge or a switch; the mobile electronic device 230 can be a car digital video recorder or other digital image recording devices; the terminal device 240 can be any type of personal computer, laptop computer, smart mobile device, or tablet computer. When the mobile electronic device 230 is a car digital video recorder, the stored data is driving information, but the present disclosure is not limited thereto.

The mobile electronic device 230 includes a positioning module 231, a wireless communication module 232, a processor 233, and a storage unit 234. The mobile electronic device 230 is the similar to the mobile electronic device 100 of FIG. 1 and will not be described herein.

The terminal device 240 has an application program 241 for setting the position coordinate range and the trusted SSID and sending the position coordinate range and the trusted SSID to the storage unit 234 to be saved therein.

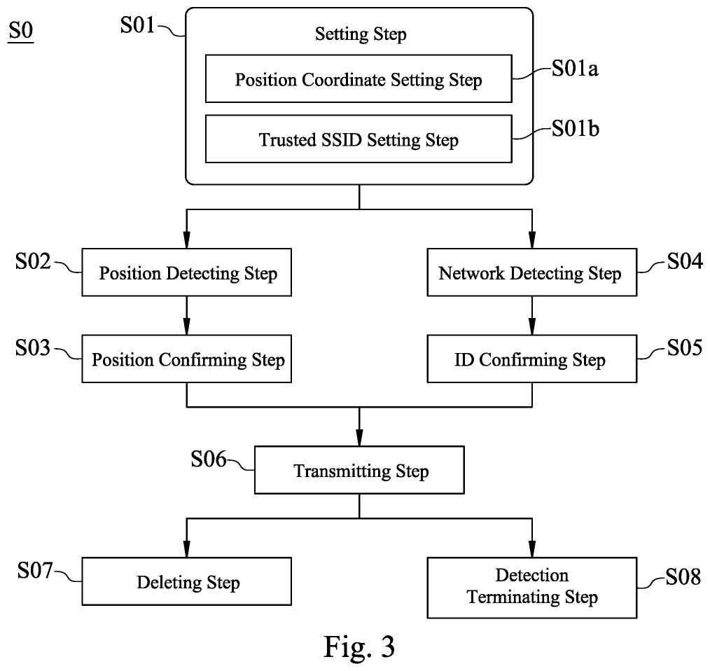

Referring to FIG. 2 and FIG. 3. FIG. 3 is a flow chart of a method S0 for using a mobile electronic device according to a third embodiment of the present disclosure. The method S0 for using a mobile electronic device enables the mobile electronic device 230 to have access to cloud services and includes a setting step S01, a position detecting step S02, a position confirming step S03, a network detecting step S04, an identity confirming step S05, a transmitting step S06, a deleting step S07, and a detection terminating step S08.

The setting step S01 includes a position coordinate setting step S01a and a trusted SSID setting step S01b. The position coordinate setting step S01a is setting the position coordinate range by the user through the application program 241 on the terminal device 240 and driving the application program 241 to transmit the position coordinate range to the storage unit 234 of the mobile electronic device 230 for storage. The trusted SSID setting step S01b provides the user to set the trusted SSID through the application program 241 and drives the application program 241 to send the trusted SSID to the storage unit 234 for storage.

The position detecting step S02 is to drive the positioning module 231 of the mobile electronic device 230 to generate the positioning signal based on the location of the vehicle. The position confirming step S03 is to drive the processor 233 of the mobile electronic device 230 to determine whether the positioning signal is within the position coordinate range and generate the position confirmation result accordingly.

The network detecting step S04 is to drive the wireless communication module 232 of the mobile electronic device 230 to detect nearby communication device 220 and obtain a wireless network name to be confirmed. The ID confirming step S05 is to drive the processor 233 to determine whether the wireless network name to be confirmed is a trusted SSID and generate the network confirmation result accordingly.

When the position confirmation result is yes (affirmative) and the network confirmation result is also yes (affirmative), the processor 233 executes the transmitting step S06, which is to drive the processor 233 to send the stored data to the external device 210 through the wireless communication module 232 and the communication device 220. It should be noted that when the position confirmation result or the network confirmation result is no (negative), the processor 233 will repeat the execution of position confirming step S03 and the ID confirming step S05 until both the position confirmation result and the network confirmation result are affirmative, and subsequently execute the transmitting step S06.

The deleting step S07 is executed after the transmitting step S06 and is to drive the processor 233 to delete the stored data from the storage unit 234.

The detection terminating step S08 is executed after the transmitting step S06 and is to drive the processor 233 to generate a network deactivation command. In this embodiment, the positioning module 231 stays in an activated mode, and the wireless communication module 232 stays in an on-mode. In other words, the positioning module 231 and the wireless communication module 232 are always turned-on. In the detection terminating step S08, the processor 233 transmits the network deactivation command to the wireless communication module 232, and the wireless communication module 232 switches from the on-mode to an off-mode according to the network deactivation command.

In another embodiment of the present disclosure, the processor 233 also generates a positioning module deactivation command in the detection terminating step S08. In this embodiment, the positioning module 231 stays in the activated mode and the wireless communication module 232 stays in the on-mode, when the processor 233 executes the detection terminating step S08, the processor 233 sends the positioning module deactivation command to the positioning module 231 and sends the network deactivation command to the wireless communication module 232. The positioning module 231 is switched from the activated mode to a deactivated mode according to the positioning module deactivation command, and the wireless communication module 232 is switched from the on-mode to the off-mode according to the network deactivation command.

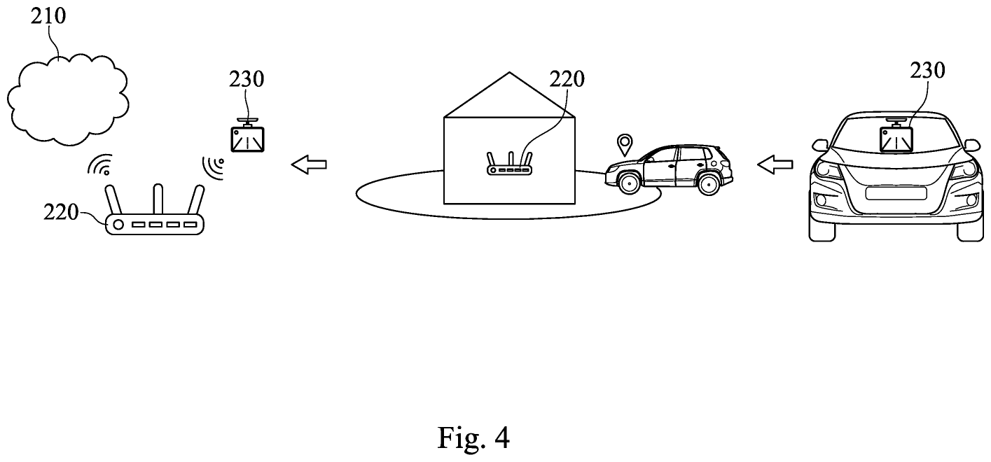

Referring to FIG. 2 and FIG. 4. FIG. 4 is a schematic view illustrating a scenario of the system 200 for using a mobile electronic device of FIG. 2. First, the user can set up the communication device 220 in their home or office and then set the position coordinate range and the trusted SSID respectively based on the GPS coordinates and the domain name of the communication device 220. Next, when the user drives the vehicle equipped with the mobile electronic device 230 (i.e. dashboard camera) to a location near the communication device 220, the processor 233 transmits the stored data to the external device 210 when the positioning signal is confirmed to be within the position coordinate range (the generated position confirmation result is yes) and the wireless network name to be confirmed is confirmed to be a trusted SSID (the generated network confirmation result is yes). Hence, the system 200 for using a mobile electronic device according to the present disclosure can achieve a two-factor authentication by location and network in data transmission, thereby further ensuring the security of data transmission. Furthermore, the present disclosure uses a communication device 220 at the fixed location to transmit driving records or driving information, and as such, compared with conventional mobile electronic devices equipped with LTE technology for transmission, the present disclosure not only reduces the system load and thermal impact on the mobile electronic device 230 caused by uploading files while driving, it also saves additional transmission telecommunications costs.

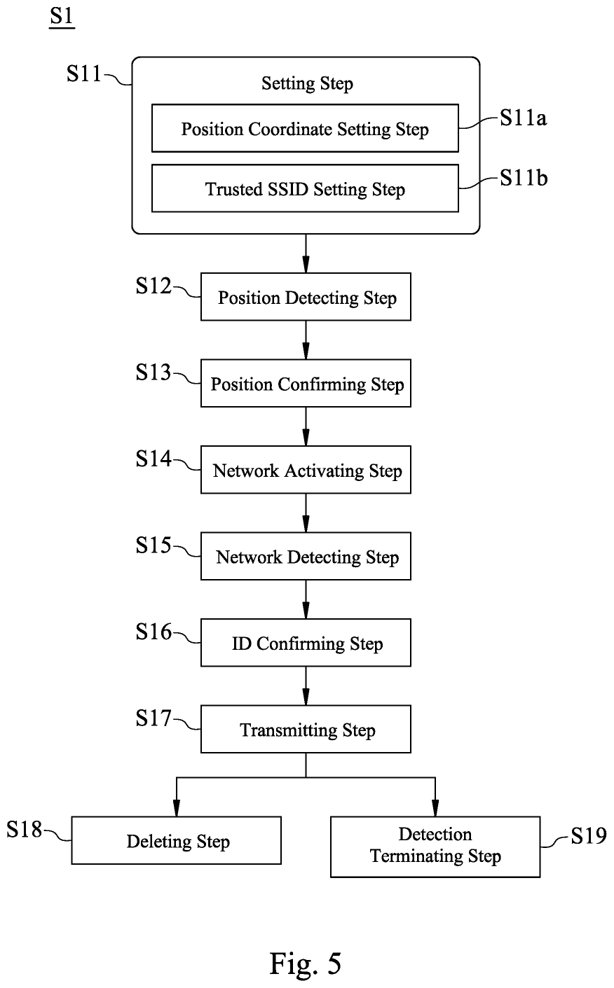

Referring to FIG. 2 and FIG. 5. FIG. 5 is a flow chart of a method S1 for using a mobile electronic device according to a fourth embodiment of the present disclosure. The method S1 for using a mobile electronic device allows the mobile electronic device 230 to be able to access cloud services. The method S1 includes a setting step S11, a position detecting step S12, a position confirming step S13, a network activating step S14, a network detecting step S15, an ID confirming step S16, a transmitting step S17, a deleting step S18, and a detection terminating step S19. The setting step S11 includes a position coordinate setting step S11a and a trusted SSID setting step S11b.

The difference between the fourth embodiment of FIG. 5 and the third embodiment of FIG. 3 is that the position detecting step S12 and the position confirming step S13 are executed before the network detecting step S15, and that the network activating step S14 is executed after the position confirming step S13 and before the network detecting step S15.

When the position confirmation result generated from the position confirming step S13 is yes, the processor 233 executes the network activating step S14 to generate a network activation command. In this embodiment, the positioning module 231 stays in the activated mode but the wireless communication module 232 starts as turned-off in the off-mode, and in the network activating step S14, the processor 233 sends the network activation command to the wireless communication module 232, and the wireless communication module 232 switches from the off-mode to the on-mode according to the network activation command for subsequently executing the network detecting step S15.

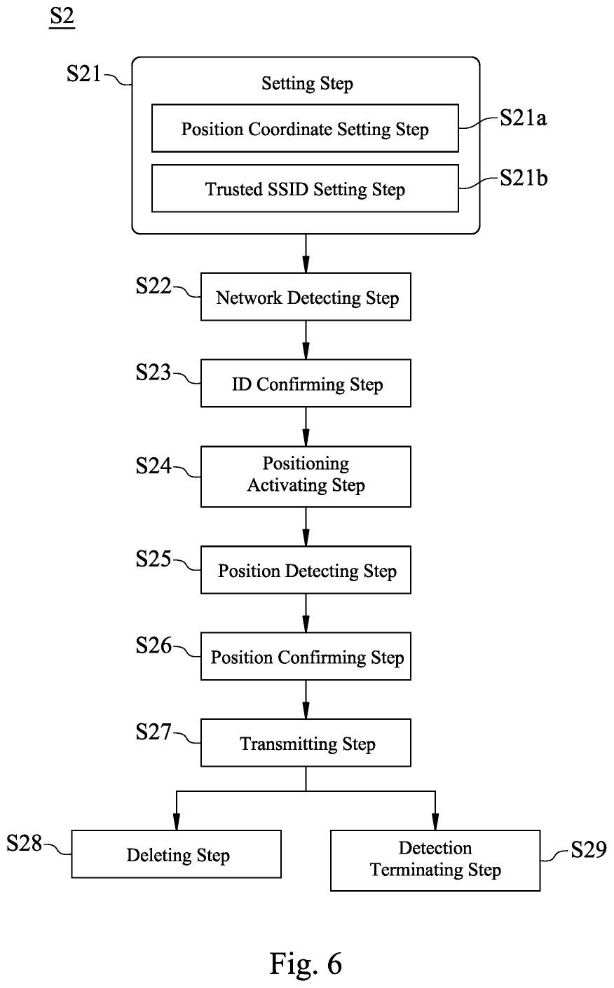

Referring to FIG. 2 and FIG. 6. FIG. 6 is a flow chart of a method S2 for using a mobile electronic device according to a fifth embodiment of the present disclosure. The method S2 for using a mobile electronic device enables the mobile electronic device 230 to access cloud services. The method S2 includes performing a setting step S21, a network detecting step S22, an ID confirming step S23, a positioning activating step S24, a position detecting step S25, a position confirming step S26, a transmitting step S27, a deleting step S28, and a detection terminating step S29. The setting step S21 includes a position coordinate setting step S21a and a trusted SSID setting step S21b.

The difference between the fifth embodiment of FIG. 6 and the third embodiment of FIG. 3 is that the network detecting step S22 and the ID confirming step S23 are executed before the position detecting step S25, and there is the positioning activating step S24 after the SSID confirming step S23 and before the position detecting step S25.

The processor 233 executes the positioning activating step S24 when network confirmation result generated from the ID confirming step S23 is yes. The positioning activating step S24 is performed to drive the processor 233 to generate a positioning module activation command. In this embodiment, the wireless communication module 232 stays turned-on in the on-mode but the positioning module 231 starts in the deactivated mode, and in the positioning activating step S24, the processor 233 transmits the positioning module activation command to the positioning module 231, and the positioning module 231 switches from the deactivated mode to the activated mode according to the positioning module activation command for subsequently executing the position detecting step S25.

Specifically, by activating the wireless communication module 232 based on the position confirmation result or activating the positioning module 231 based on the network confirmation result, the power consumption of the mobile electronic device 230 can be further reduced, thereby saving system load and thus avoiding system thermal issues.

In summary, the present disclosure has the following advantages. First, the mobile electronic device does not need to upload the stored data while the vehicle is driving, thereby saving additional transmission telecommunications costs, and further reducing the system load and thermal impact on the mobile electronic device caused by uploading files while driving. Second, by confirming that the position confirmation result is yes and the network confirmation result is yes, it is a two-factor verification method for checking the transmission condition of stored data. It can achieve a two-factor authentication by location and network in data transmission, which further ensures the security of data transmission.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A mobile electronic device, comprising:
a positioning module for generating a positioning signal;
a wireless communication module for detecting a communication device and obtaining a wireless network name to be confirmed; and
a processor, signally connected to the positioning module and the wireless communication module to generate a position confirmation result by confirming whether the positioning signal is within a position coordinate range, and to generate a network confirmation result by confirming whether the wireless network name to be confirmed is a trusted Service Set Identifier (SSID);
wherein, when the position confirmation result is yes and the network confirmation result is yes, the processor sends a stored data through the wireless communication module and the communication device to an external device signally connected to the communication device.

2. The mobile electronic device of claim 1, wherein, when the position confirmation result is yes, the processor generates and sends a network activation command to the wireless communication module to confirm whether the wireless network name to be confirmed is the trusted SSID for generating the network confirmation result;
wherein the positioning module stays in an activated mode, and the wireless communication module switches from an off-mode to an on-mode according to the network activation command.

3. The mobile electronic device of claim 1, wherein the positioning module stays in an activated mode, and the wireless communication module stays in an on-mode.

4. The mobile electronic device of claim 1, wherein, when the network confirmation result is yes, the processor generates and sends a positioning module activation command to the positioning module to confirm whether the positioning signal is within the position coordinate range for generating the position confirmation result;
wherein the positioning module switches from a deactivated mode to an activated mode according to the positioning module activation command, and the wireless communication module stays in an on-mode.

5. The mobile electronic device of claim 1, wherein the processor generates a network deactivation command after sending the stored data to the external device;
wherein the processor sends the network deactivation command to the wireless communication module, and the wireless communication module switches from an on-mode to an off-mode according to the network deactivation command.

6. The mobile electronic device of claim 1, further comprising:
a storage unit signally connected to the processor for storing the position coordinate range, the trusted SSID, and the stored data;
wherein the processor deletes the stored data in the storage unit after sending the stored data to the external device.

7. A system for using a mobile electronic device, the system comprising:
an external device;
a communication device, signally connected to the external device; and
a mobile electronic device, signally connected to the communication device and comprising:
a positioning module for generating a positioning signal;
a wireless communication module for detecting the communication device and obtain a wireless network name to be confirmed; and
a processor, signally connected to the positioning module and the wireless communication module to generate a position confirmation result by confirming whether the positioning signal is within a position coordinate range, and to generate a network confirmation result by confirming whether the wireless network name to be confirmed is a trusted SSID;
wherein, when the position confirmation result is yes and the network confirmation result is yes, the processor sends a stored data through the wireless communication module and the communication device to the external device.

8. The system of claim 7, wherein, when the position confirmation result is yes, the processor generates and sends a network activation command to the wireless communication module to confirm whether the wireless network name to be confirmed is the trusted SSID for generating the network confirmation result;
wherein the positioning module stays in an activated mode, and the wireless communication module switches from an off-mode to an on-mode according to the network activation command.

9. The system of claim 7, wherein the positioning module stays in an activated mode, and the wireless communication module stays in an on-mode.

10. The system of claim 7, wherein, when the network confirmation result is yes, the processor generates and sends a positioning module activation command to the positioning module to confirm whether the positioning signal is within the position coordinate range for generating the position confirmation result;
wherein the positioning module switches from a deactivated mode to an activated mode according to the positioning module activation command, and the wireless communication module stays in an on-mode.

11. The system of claim 7, wherein, the processor generates a network deactivation command after sending the stored data;
wherein the processor sends the network deactivation command to the wireless communication module, and the wireless communication module switches from an on-mode to an off-mode according to the network deactivation command.

12. The system of claim 7, wherein the mobile electronic device further comprises:
a storage unit signally connected to the processor for storing the position coordinate range, the trusted SSID, and the stored data;
wherein the processor deletes the stored data in the storage unit after sending the stored data to the external device.

13. The system of claim 12, further comprising:
a terminal device signally connected to the mobile electronic device and comprising an application program for setting the position coordinate range and the trusted SSID and to send the position coordinate range and the trusted SSID to the storage unit.

14. A method for using a mobile electronic device, the method comprising:
driving a positioning module of the mobile electronic device to generate a positioning signal;
driving a processor of the mobile electronic device to confirm whether the positioning signal is within a position coordinate range and generate a position confirmation result;
driving a wireless communication module of the mobile electronic device to detect a communication device and obtain a wireless network name to be confirmed; and
driving the processor of the mobile electronic device to confirm whether the wireless network name to be confirmed is a trusted SSID and generate a network confirmation result;
wherein, when the position confirmation result is yes and the network confirmation result is yes, the processor sends a stored data through the wireless communication module and the communication device to an external device.

15. The method of claim 14, further comprising:
driving the processor to generate and send a network activation command to the wireless communication module to confirm whether the wireless network name to be confirmed is the trusted SSID and generate the network confirmation result;
wherein, when the position confirmation result is yes, the processor sends the network activation command to the wireless communication module, the positioning module stays in an activated mode, and the wireless communication module switches from an off-mode to an on-mode according to the network activation command.

16. The method of claim 14, further comprising:
driving the processor to generate and send a positioning module activation command to the positioning module to confirm whether the positioning signal is within the position coordinate range and generate the position confirmation result;
wherein, when the network confirmation result is yes, the processor generates and sends the positioning module activation command to the positioning module, the positioning module switches from a deactivated mode to an activated mode according to the positioning module activation command, and the wireless communication module stays in an on-mode.

17. The method of claim 14, further comprising:
driving the processor to generate a network deactivation command after sending the stored data;
wherein the processor sends the network deactivation command to the wireless communication module, and the wireless communication module switches from an on-mode to an off-mode according to the network deactivation command.

18. The method of claim 14, further comprising:
driving the processor to delete the stored data in a storage unit of the mobile electronic device after sending the stored data.

19. The method of claim 18, further comprising:
setting the position coordinate range through an application program of a terminal device and sending the position coordinate range to the storage unit; and
setting the trusted SSID through the application program of the terminal device and sending the trusted SSID to the storage unit.
